(19) United States
(12) Patent Application Publication
(10) Pub. No.: US 2026/0084349 A1
(43) Pub. Date: Mar. 26, 2026

(54) BIPOLAR PLATE PRODUCTION METHOD, BIPOLAR PLATE AND ELECTROMECHANICAL CELL

(71) Applicant: SCHAEFFLER Technologies AG & CO. KG, Herzogenaurach (DE)

(72) Inventors: Roland Karpinski, Mohrendorf (DE); Heiko Ballmes, Mohrendorf (DE); Philipp Mayer, Nurnberg (DE); Torsten Keller, Hessdorf (DE)

(73) Assignee: SCHAEFFLER Technologies AG & CO. KG, Herzogenaurach (DE)

(21) Appl. No.: 19/109,840

(22) PCT Filed: Jul. 19, 2023
(86) PCT No.: PCT/DE2023/100526

§ 371 Date: Mar. 7, 2025

(30) Foreign Application Priority Data
Sep. 9, 2022 (DE) 10 2022 122 896.7
Jul. 18, 2023 (DE) 10 2023 118 897.6

(51) Int. Cl. B29C 43/02; B29L 31/34; H01M 8/0213; H01M 8/0221; H01M 8/0226; H01M 8/0247; H01M 8/0267

(52) U.S. Cl. CPC B29C 43/021; H01M 8/0213; H01M 8/0221; H01M 8/0226; H01M 8/0247; H01M 8/0267; B29L 2031/3468

(57) ABSTRACT

The disclosure relates to a bipolar plate production method for producing a bipolar plate, in particular for an electrochemical cell, which method comprises the following steps:
providing two foil sections made of a polymer graphite material comprising at least one polymer and at least 75 wt. % of an electrically conductive filler comprising predominantly graphite and also carbon black,
inserting the two foil sections into an embossing and molding tool, closing the tool, wherein the foil sections are embossed and tightly connected to one another at their edges,
forming a hollow structure between the foil sections by means of gas pressure differences at the foil surfaces, wherein the foil sections rest against surface structures of tool surfaces, which face one another, of the embossing and molding tool,
removing the bipolar plate, formed from the foil sections, from the embossing and molding tool after the foil sections have solidified.

### CROSS-REFERENCE TO RELATED APPLICATIONS

This application is the U.S. National Phase of PCT Appln. No. PCT/DE2023/100526, filed Jul. 19, 2023, which claims the benefit of German Patent Appln. Nos. 102022122896.7, filed Sep. 9, 2022 and 102023118897.6, filed on Jul. 18, 2023, the entire disclosures of which are incorporated by reference herein.

### TECHNICAL FIELD

The disclosure relates to a bipolar plate production method for producing a bipolar plate, in particular for an electrochemical cell, in particular a fuel cell. The disclosure also relates to a bipolar plate and an electrochemical cell.

### BACKGROUND

DE 10 2008 028 549 A1 discloses a method for producing a fuel cell bipolar plate with thermoplastic plates. The individual plates are made from a resin mixture comprising an electrically conductive thermoplastic polymer composition and a solvent. After the individual panels are formed and cut, they are assembled to form a bipolar plate.

Another method for producing an electrically conductive bipolar plastic plate intended for use as an electrode in a fuel cell battery is described in EP 1 506 585 B1. In this case, the production of a structure with electrically conductive, carbonized or graphitized reinforcing fibers is proposed, wherein a mechanical orientation of the reinforcing fibers by needling in a first direction corresponding to the preferred electrical conduction path is intended to lead to a higher conductivity in said first direction. EP 1 506 585 B1 proposes graphitized PAN fibers and graphitized pitch fibers as reinforcing fibers. In the finished product, the fibers are in the form of a matrix, which may also contain filler fibers. Possible processes by which the matrix is obtained are mentioned in EP 1 506 585 B1 as thermoforming, membrane molding, pressure casting, resin transfer molding, molding under pressure and vacuum, lamination and embossing presses.

DE 10 2011 116 993 A1 relates to a device for producing a metallic foil component which is intended to be usable as a fuel cell component. At the beginning of the production process, two foils are placed on top of each other and connected to each other in a fluid-tight manner, at least in some areas. By introducing a fluid under pressure into a space formed between the foils, wherein the foils are located in a forming tool, the shape of the foils is intended to adapt to the surface structures of the forming tools. DE 10 2011 116 993 A1 stipulates that the tool parts of the forming tool are moved towards each other during the forming process. In this process, fluid is released in a controlled manner from the cavity formed between the foils.

Another method for producing a metallic bipolar plate for a fuel cell stack is described, for example, in DE 10 2010 020 178 A1. In particular, DE 10 2010 020 178 A1 deals with the production of gas distribution structures, wherein shear cutting is recommended as the manufacturing technology.

DE 10 2009 044 112 A1 describes a method for producing a microstructured composite component. For this purpose, a first and a second foil made of thermoplastic polymer material are arranged between mold components which have microstructured hollow shapes to be filled by the foil material and which are heated in the contact area with the foils. An overpressure is generated between the two foils, which pushes the foils into the hollow molds. Finally, the foils are pressed together and cooled. After demolding, the microstructured composite component has microstructures that provide channels for liquids.

U.S. Pat. No. 6,217,699 B1 discloses a device and a method for joining previously thermoformed plastic foils by welding.

DE 12 50 627 A describes a method for producing a double-walled hollow body from thermoplastic foils. For this purpose, two heated plastic foils in a plasticized state are introduced into die-like molds, where they are at least partially welded together and formed within the weld edges by a pressure difference.

U.S. Pat. No. 3,982,877 A discloses a laminated, rib-reinforced hollow body and a method and device for producing such a body. At least two foils are used, at least one of which is made of heated thermoplastic material and at least one other foil has grooves or projections on the surface that form fluid channels. The foils are heated and arranged in opposing molds, wherein one of the molds forms rib-shaped cavities. The thermoplastic foil is arranged in contact with the rib-shaped cavities. After the molds are closed, a fluid is fed between the foils and the thermoplastic foil is molded into the cavities and the foils are bonded together. The thermoplastic material for forming a foil can contain a filler in an amount of 1 to 70 wt. %, wherein possible fillers are asbestos, carbon, glass fibers, calcium phosphate, calcium carbonate, kaolinitic clay, silicon dioxide, titanium dioxide, bentonite, talc and mica.

### SUMMARY

The disclosure is based on the object of further developing the production of bipolar plates for electrochemical cells compared to the aforementioned prior art, wherein a particularly favorable ratio between equipment expenditure, geometric precision of the product to be produced and process reliability is sought. Furthermore, a bipolar plate and an electrochemical cell are to be provided.

This object is achieved according to the disclosure by a bipolar plate production method according to claim 1, a bipolar plate produced thereafter according to claim 9 and an electrochemical cell according to claim 10. Embodiments and advantages of the disclosure explained below in relation to the bipolar plate production method similarly also apply to the bipolar plate produced thereby and vice versa.

The bipolar plate production method generally comprises the following steps:
providing two foil sections made of a polymer graphite material comprising at least one polymer and at least 75 wt. % of an electrically conductive filler comprising predominantly graphite and also carbon black,
inserting the two foil sections into an embossing and molding tool,
closing the tool, wherein the foil sections are embossed and tightly connected to one another at their edges,
forming a hollow structure between the foil sections by means of gas pressure differences, in particular pressure differences of air, at the foil surfaces, wherein the foils rest against the tool surfaces facing one another,
removing the bipolar plate, formed from the foil sections, after the foil sections have solidified.

It is therefore a combined method that combines mechanical deformation in the form of embossing with forming using pressure differences in a gaseous medium. A first change in the geometric parameters of the foil sections occurs through embossing directly after the foil sections are inserted into the embossing and molding tool, which is also referred to as the tool for short. A change in geometric parameters includes, among other things, changes in wall thickness and the formation of three-dimensional embossed structures.

The majority of the change in shape of the foil sections is achieved by subsequent gas pressure, which can be present as negative pressure and/or positive pressure. The initial embossing of the foil sections already ensures gas tightness between the foil sections.

The term “foil sections” is used in this case for any flat polymer-graphitic starting products. This also applies to cases where the starting products are in the form of sheets or plates. Typical wall thicknesses or foil thicknesses of the foils are in the range of 0.1 mm to 0.5 mm, in particular in the range of 100 to 300 μm.

In any case, both foil sections are inserted into the tool together. Individual forming of foil sections is not provided for. Depending on the composition and thickness of the foil sections, preheating the foil sections before inserting them into the tool may be considered. Likewise, the degree of preheating of the tool parts of the embossing and molding tool depends in particular on the material properties of the foil sections.

A “polymer-graphitic material” is understood here to mean a material which contains a proportion of polymer and a total proportion of at least 75 wt. % of electrically conductive fillers in the form of predominantly graphite and also carbon black.

In principle, the polymer can be selected from thermoplastic or thermosetting material, although it does not necessarily have to be made of the same material. In particular, fiber reinforcement of the foils comes into consideration. In the case of thermoplastic materials, the process commonly referred to as solidification occurs as setting. In the case of thermosetting materials, solidification is a process of hardening. Polypropylene (PP) or polyphenylene sulfide (PPS) have proven particularly suitable as thermoplastic materials. Polyester resins or epoxy resins have proven particularly suitable as thermosetting materials.

The maximum proportion of filler or the minimum proportion of polymer in the foil is reached when foil formation is no longer possible and the polymer content is no longer sufficient to bind the filler particles into a foil. This can be determined experimentally in a simple manner.

According to one possible method variant, the material bond between the foil sections at their edges is already created directly by closing the embossing and molding tool. Alternatively, it may be provided that the foil sections are only permanently connected, in particular materially bonded, to one another in a later phase of the production process, in any case still within the embossing and hollow forming tool, wherein heating devices of the tool parts can be provided for this purpose, which heat the tool parts and thus also the foil sections in defined areas, usually in edge areas of the foil sections, beyond the otherwise given level.

A suitable production plant with which the bipolar plate intended for use in a stack of electrochemical cells is produced generally comprises a two-part embossing and molding tool which is designed both for embossing a two-layer foil arrangement and has fluid connections, in particular vacuum and/or compressed air connections, for forming at least one cavity between the foils by gas pressure.

The foil from which the foil sections are cut has a proportion of at least 75 wt. % of electrically conductive fillers, here predominantly graphite, in particular ground graphite, and also carbon black, in order to provide an electrical conductivity of at least 20 S/cm, in particular at least 100 S/cm, sufficient for the intended use in a stack of electrochemical cells. This minimum value to be achieved for electrical conductivity is required for a maximum foil thickness of 0.5 mm at a room temperature of 20 to 24° C. for the application of the foil in a bipolar plate.

A “through-plane measurement method” (TPV) is used to first determine the area-specific electrical resistance of the foil, wherein a contact pressure of the measuring electrodes (=gold-plated contact pins with 39° tip) of 40 N/cm² is applied to the foil. Surface-specific electrical contact resistances of ≤10 mΩ·cm² at a room temperature in the range of 20 to 24° C. are required. The determined electrical resistance value is then converted into electrical conductivity.

The filler used in the foil with a total proportion of at least 75 wt. % preferably comprises a proportion of 5 to 10 wt. % carbon black and 65 to 70 wt. % ground graphite (calculated based on the composition of the foil).

The filler particles of the electrically conductive filler preferably have a grain distribution with a d₉₀-value of at most 200 μm, preferably 75 μm.

To process the foil in the embossing and molding tool, the foil sections are advantageously brought to a temperature above the heat distortion temperature and below the melting temperature. This not only ensures good formability but also virtually completely prevents the separation of components, particularly filler and plastic, in the foil. Metallic components of the foil are not provided for in typical designs, but are not categorically excluded. Metal is by no means the main component of the foils. For example, a proportion of up to 20 wt. % metal particles, for example from at least one of the metals from the group titanium, titanium alloys, aluminum, aluminum alloys, vanadium, vanadium alloys, such as Ti6Al4V, can be mixed into the foil.

Depending on the materials used and the geometric structures to be created, it may be sufficient to use negative pressure to apply the foil sections to the three-dimensionally structured surfaces of the tool parts according to the intended shape of the end product. According to a further developed method variant, compressed air is additionally introduced between the foil sections, i.e., into the cavity to be formed. In order to support the heating of the foil sections in the tool, this can be tempered compressed air, i.e., compressed air brought to an increased temperature level. In order to assist the subsequent solidification of the bipolar plate formed from the foil sections after it has assumed its final shape, cooling air can be introduced between the foil sections at some point instead of the heated compressed air. The foil sections are thus initially exposed to hot air in the tool and, at a later stage of the method, to cooled air. In all cases, the same connections that are initially used to apply a negative pressure can be used to eject the finished bipolar plate formed from the foil sections from the tool.

A significant advantage of the bipolar plate production method according to the application compared to processes that provide for a single forming of plate-shaped elements is that the simultaneous processing of both foil sections in the embossing and molding tool eliminates any need for alignment of the foil sections after their shaping. Optionally, the production of the bipolar plate from the foil sections is followed by a leak test. The same openings formed at certain points between the foil sections that were already used to introduce compressed air during the formation of the bipolar plate can be used as connections for the leak test. Furthermore, the same openings can be used to pass coolant, in particular cooling water, through the bipolar plates within the subsequent stack of electrochemical cells, in particular a fuel cell stack, which comprises a plurality of bipolar plates of the type described.

A bipolar plate produced according to the method according to the disclosure has at least one, in particular channel-shaped, hollow structure for fluid passage through the bipolar plate.

An electrochemical cell, in particular a fuel cell, electrolysis cell or redox flow cell, comprises at least one such bipolar plate according to the disclosure.

The bipolar plate formed by the process according to the disclosure is therefore suitable for use in electrochemical cells, in particular fuel cells with polymer electrolyte membrane, electrolysis cells for the electrolysis of water with polymer electrolyte membrane or redox flow cells with polymer ion exchange membrane.

### BRIEF DESCRIPTION OF THE DRAWINGS

Below, several exemplary embodiments of the disclosure are explained in by way of example by means of the drawings. The figures show the following in an, in parts, roughly schematized manner:

FIG. 1 shows a production plant to illustrate a bipolar plate production method,

FIG. 2 shows the arrangement according to FIG. 1 in a partially more detailed representation,

FIG. 3 shows a modified plant to illustrate a bipolar plate production method in a representation the same as FIG. 2,

FIG. 4 shows a bipolar plate in a three-dimensional view, and

FIG. 5 shows a schematic representation of an electrochemical cell and a cell stack.

### DETAILED DESCRIPTION

Unless otherwise stated, the following explanations relate to both exemplary embodiments. Parts that correspond to each other or have basically the same effect are denoted with the same reference signs in all the figures.

A production plant 1 uses foil sections 2, 3 made of an electrically conductive polymer-graphitic material to produce bipolar plates 4 for electrochemical cells, in particular PEM fuel cells. Within a completed stack of electrochemical cells, each bipolar plate 4 separates a half-cell of a first electrochemical cell from a half-cell of another, similarly constructed electrochemical cell. With regard to the basic structure and function of the stacked electrochemical cells, in particular fuel cells, reference is made to the prior art cited at the outset.

The foil sections 2, 3 are conveyed in a manner not shown in detail and brought to the temperature required for further processing in a preheating device 5. In a superimposed arrangement, the foil sections 2, 3 are inserted into an embossing and molding tool 6, shown here and below in section, which comprises a lower tool part 7 and an upper tool part 8.

The embossing and hollow forming tool 6 is then closed, which means an embossing process in which the two foil sections 2, 3 are materially bonded together at the contact points and geometry is already partially transferred from the tool parts 7, 8 to the foil sections 2, 3, which are being further processed to form the bipolar plate 4. The foil sections 2, 3 in particular contact sealing areas 9, 10 of the tool parts 7, 8.

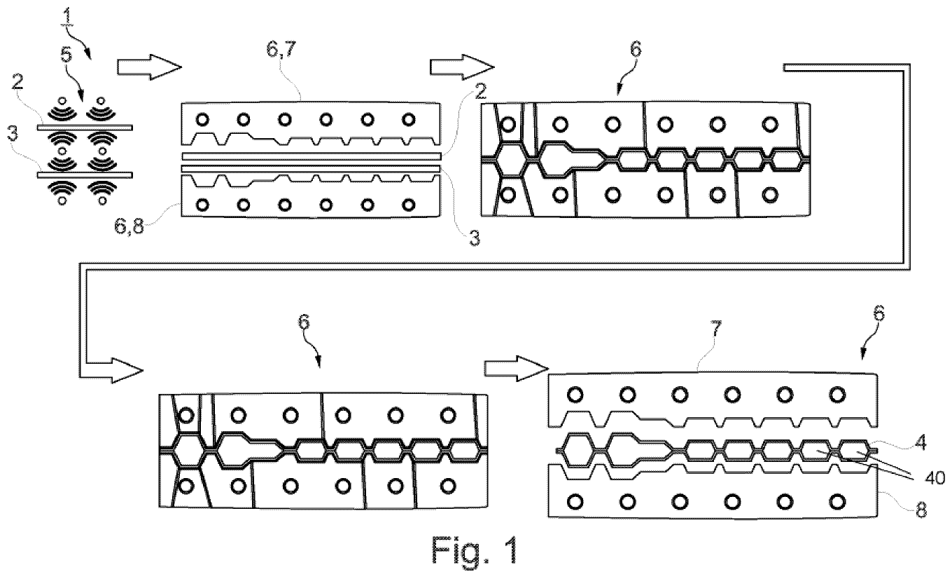

In the further production method, the shape of the foil sections 2, 3 is adapted to the shape of surface structures 11, 12 of the tool parts 7, 8 by the action of negative pressure and/or positive pressure, as explained in more detail below. Referring to the symbolic representation in FIG. 1, this forming step still takes place in the upper line of the figure illustrating the production method. Subsequently, in FIG. 1 on the left in the bottom row, the finished bipolar plate 4 formed from the foil sections 2, 3 is cooled within the still closed embossing and molding tool 6. The last step is the removal and demolding of the bipolar plate 4. The demolded bipolar plate 4 is shown in FIGS. 1, 2 and 3 in a sectional view, such that the hollow structure 40 formed between the connected foil sections 3, 2, here in the form of a channel, can be seen, which conducts fluid through the bipolar plate 4. Typically, a coolant, such as cooling water, is passed through the hollow structure 40.

Channels 13, 14 are formed in each of the tool parts 7, 8, which can be used for heating or cooling as required. Alternatively, separate heating channels and cooling channels can be provided. The integration of electrical heating elements into the tool parts 7, 8 is also possible. Such heating elements can in particular be used to effect or support the material bond of the foil sections 2, 3. Furthermore, compressed air channels 15, 16 are formed in the tool parts 7, 8, each of which extends from a collecting line 17, 18 to the tool surface, which has the surface structure 11, 12. In this case, the term “compressed air channel” is used regardless of the absolute pressure of the gas in the channel in question. In particular, the absolute pressure can be lower than the ambient air pressure.

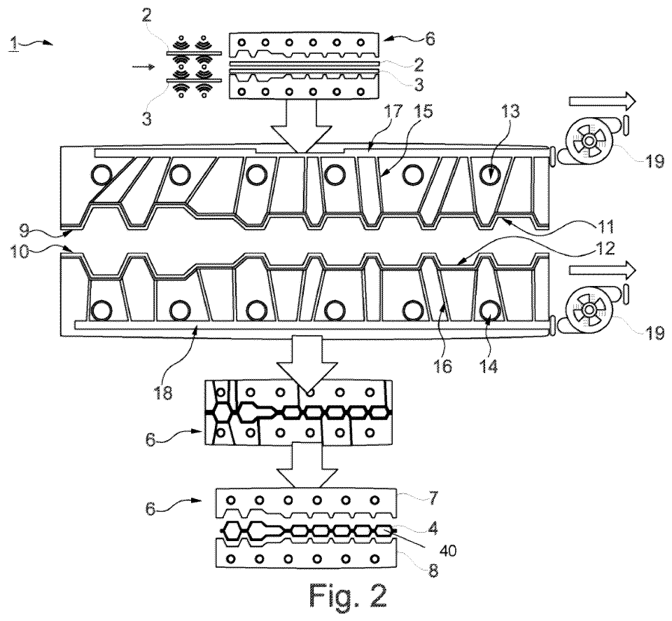

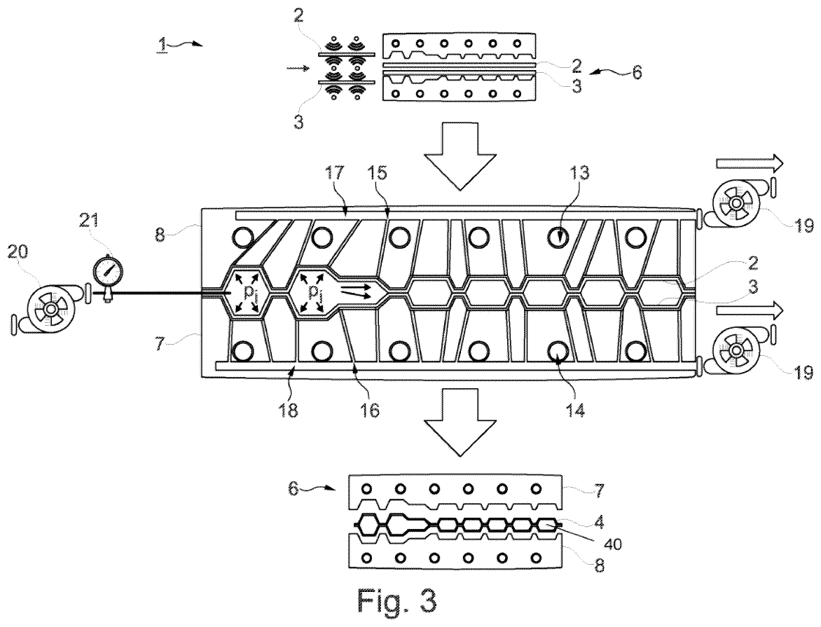

As can be seen from FIGS. 2 and 3, a vacuum pump 19 is connected to each collecting line 17, 18. Using the vacuum pumps 19, a negative pressure is generated which sucks the foil sections 2, 3 onto the surface structures 11, 12 of the tool parts 7, 8. In the variant according to FIG. 3, a compressor 20 is also used to generate an internal pressure pᵢ between the foil sections 2, 3, which can be monitored by means of a pressure gauge 21. Both in the variant according to FIGS. 1 and 2 and in the variant according to FIG. 3, the demolding of the bipolar plate 4 is assisted by applying compressed air to the outer surfaces of the bipolar plate 4 via the compressed air channels 15, 16.

Compressed air, which is to be introduced between the foil sections 2, 3, is tempered depending on the stage of the method. By means of heated compressed air, not only the foil sections 2, 3 but also the inner sides of the tool parts 7, 8 can be heated quickly. The same applies to the demolding of the bipolar plate 4. When using thermoplastic materials, the temperature levels of the compressed air are adapted to the forming temperature or demolding temperature of the material. In the case of thermosetting materials, the viscosity for forming is first reduced by setting suitable temperature levels. The further temperature control depends on the activation temperature of the hardener contained in the material of the foil sections 2, 3. By accelerating the temperature-dependent cross-linking reactions, the solidification of the bipolar plate 4 after forming is supported and thus the cycle time is reduced.

After removing any excess material, the bipolar plate 4 can be used for assembly in an electrochemical cell or a cell stack formed therewith, regardless of the materials used, without further processing.

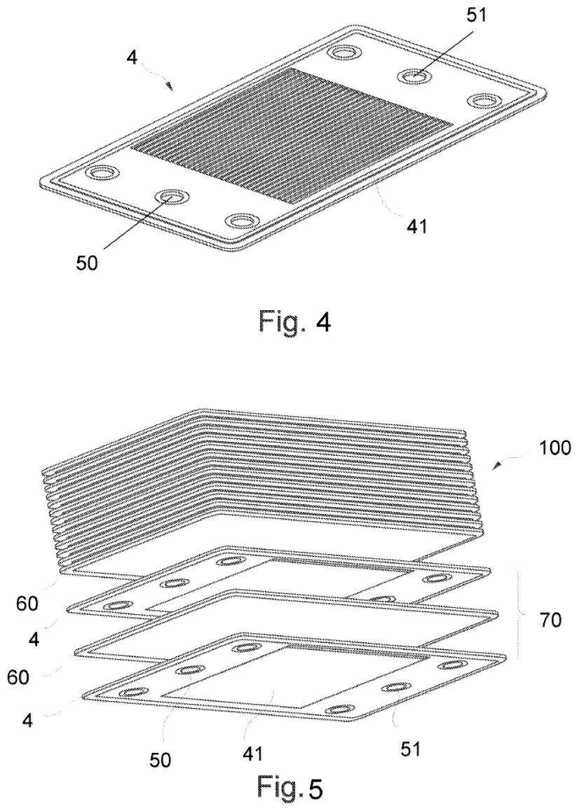

FIG. 4 shows a bipolar plate 4 in a three-dimensional view. This has an active field 41 on each of its sides facing away from the hollow structure 40 (see FIGS. 1 to 3), which is not visible here, in the area of which electrochemical reactions take place in an electrochemical cell 70 (see FIG. 5). The rectangular bipolar plate 4 has three fluid passage openings on each of its short sides. The middle fluid passage openings serve as a coolant supply opening 50 and a coolant discharge opening 51. These are fluidically connected to the hollow structure 40 within the bipolar plate 4 and enable a supply of coolant to the hollow structure 40, which flows through the hollow structure 40, and a discharge of the coolant after leaving the hollow structure 40.

FIG. 5 shows a schematic representation of an electrochemical cell 70 in a cell stack 100 comprising a plurality of such electrochemical cells 70. The electrochemical cell 70 comprises two bipolar plates 4 and a polymer electrolyte membrane 60 arranged therebetween, wherein adjacent electrochemical cells 70 share a bipolar plate 4.

### LIST OF REFERENCE SYMBOLS

1 Production plant
2 Foil section
3 Foil section
4 Bipolar plate
5 Preheating device
6 Embossing and molding tool
7 Lower tool part
8 Upper tool part
9 Sealing area of the upper tool part
10 Sealing area of the lower tool part
11 Surface structure of the upper tool part
12 Surface structure of the lower tool part
13 Channel for tempering fluid in the upper tool part
14 Channel for tempering fluid in the lower tool part
15 Compressed air channel in the upper tool part
16 Compressed air channel in the lower tool part
17 Collecting line in the upper tool part
18 Collecting line in the lower tool part
19 Vacuum pump
20 Compressor
21 Pressure gauge
40 Hollow structure
41 Active field
50 Coolant supply opening
51 Coolant discharge opening
60 Polymer electrolyte membrane
70 Electrochemical cell
100 Cell stack
pᵢ Internal pressure

1. A bipolar plate production method for producing a bipolar plate for an electrochemical cell, the method having the following steps:
providing two foil sections made of a polymer graphite material comprising at least one polymer and at least 75 wt. % of an electrically conductive filler comprising predominantly graphite and also carbon black,
inserting the two foil sections into an embossing and molding tool, closing the tool, wherein the foil sections are embossed and tightly connected to one another at their edges,
forming a hollow structure between the foil sections with gas pressure differences at the foil surfaces, wherein the foil sections rest against surface structures of tool surfaces, which face one another, of the embossing and molding tool,
removing the bipolar plate formed from the foil sections, from the embossing and molding tool after the foil sections have solidified.

2. The method according to claim 1, wherein the foil sections with a maximum foil thickness of 0.5 mm and an electrical conductivity of at least 20 S/cm (at 20 to 24° C.) are used.

3. The method according to claim 1 wherein the foil sections are heated before being inserted into the tool.

4. The method according to claim 1, wherein the foil sections are sucked onto the surface structures of the tool surfaces by negative pressure.

5. The method according to claim 4, wherein the suction of the foil sections is supported by tempered compressed air introduced between the foil sections.

6. The method according to claim 4, wherein the solidification of the bipolar plate is at least partly caused by cooling air which is introduced between the foil sections.

7. The method according to claim 1, wherein the foil sections are materially bonded to one another immediately upon closing of the embossing and molding tool.

8. The method according to claim 1, wherein the foil sections are only materially bonded together after their final shaping by partial heating of the tool with the aid of gas pressure differences acting in the tool.

9. A bipolar plate manufactured according to the method of claim 1, having at least one channel-shaped, hollow structure for fluid passage through the bipolar plate.

10. An electrochemical cell comprising at least one bipolar plate according to claim 9.
